(19) United States
(12) Patent Application Publication
(10) Pub. No.: US 2019/0090011 A1
(43) Pub. Date: Mar. 21, 2019

(54) REALTIME IN-VIDEO IMAGE RENDERING

(71) Applicants: Venkat Kankipati, Fremont, CA (US); Pavan Kankipati, Telangana (IN)

(72) Inventors: Venkat Kankipati, Fremont, CA (US); Pavan Kankipati, Telangana (IN)

(21) Appl. No.: 16/124,096

(22) Filed: Sep. 6, 2018

Related U.S. Application Data
(60) Provisional application No. 62/554,744, filed on Sep. 6, 2017.

(51) Int. Cl. H04N 21/431; H04N 21/81

(52) U.S. Cl. CPC H04N 21/4316; H04N 21/8146

(57) ABSTRACT

An improved system and method to track and render both 2D & 3D images on any digital surface (rigid and continuously deforming) in live or pre-recorded video. This system and method is applicable to both hardware and cloud deployments.

### PRIORITY

This application claims priority of U.S. Provisional Patent Application Ser. No. 62/554,744 filed Sep. 6, 2017 entitled Dynamic Tracking and Overlay of Objects on Selected Target Areas (both rigid & non-rigid surfaces) in a Live Broadcast (video) Feed, the teachings of which are incorporated herein.

### BACKGROUND

The ability to insert 2-dimensional (2D) (Example: Outdoor advertising billboard) and 3-dimensional (3D) objects (Example: product placements) has long existed. Examples of the methods used are Virtual Effects (VFX), Blue/Green screen photography etc. However, all of these methods apply during video production and require special tools and equipment. Furthermore, existing methods require production of multiple videos for region specific video distribution.

### SUMMARY OF THE INVENTION

An improved dynamic system and method to track and render both 2D & 3D images, in real-time on any digital surface (rigid and continuously deforming) in live or pre-recorded video using Artificial Intelligence (AI) technologies during broadcast/distribution—thereby allowing region specific 2D & 3D images to be placed in-video during video distribution.

### BRIEF DESCRIPTION OF THE DRAWINGS

FIG. 1 illustrates a system and platform configured to execute a method to track and render both 2D & 3D images, in real-time on any digital surface (rigid and continuously deforming) in live or pre-recorded video; and

FIGS. 2 and 3 illustrate a method to track and render both 2D & 3D images, in real-time on any digital surface (rigid and continuously deforming) in live or pre-recorded video.

### DETAILED DESCRIPTION

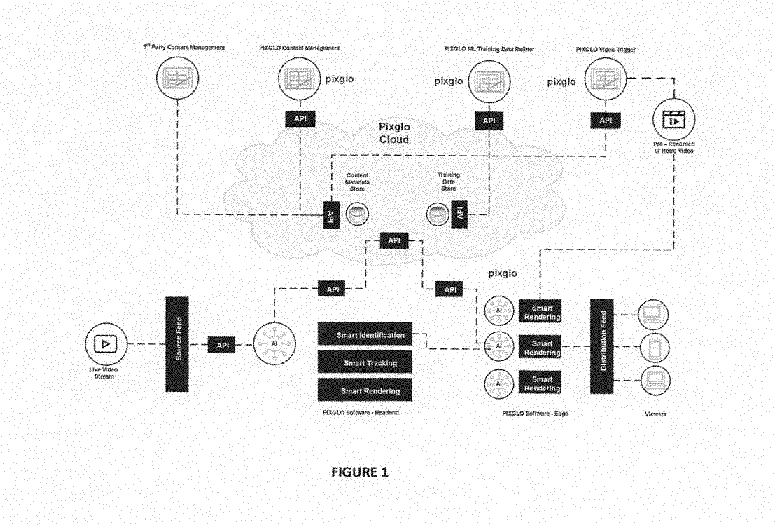

Referring to FIG. 1 there is shown a system and platform configured to execute a method to track and render both 2D & 3D images, in real-time on any digital surface (rigid and continuously deforming) in live or pre-recorded video.

In FIG. 1, there is shown:

Content Management Portal: The Content Management Portal is configured to help customers manage content, Regions of Interest—location in the video where the rendered image needs to appear. This Content Management Portal in one embodiment can be a replacement of an existing image or an insertion of a new image, images, analytics, dashboards and reports etc.

Pixglo Cloud: The secure, reliable and scalable Cloud stores content and training metadata.

Stream Ingestion Module: The Stream Ingestion module enables the ingestion and processing of video streams of various industry standard formats.

Core Imaging Engine: The Core Imaging Engine encompasses AI-driven (Computer Vision, Machine/Deep-Learning etc.) algorithms for Smart Identification, Smart Tracking and Smart Rendering.

Video Tagger: The Video Tagger enables the identification of Regions of Interest in a video.

Training Data Refiner: The Training Data Refiner enables the constant refinement of the machine's training data.

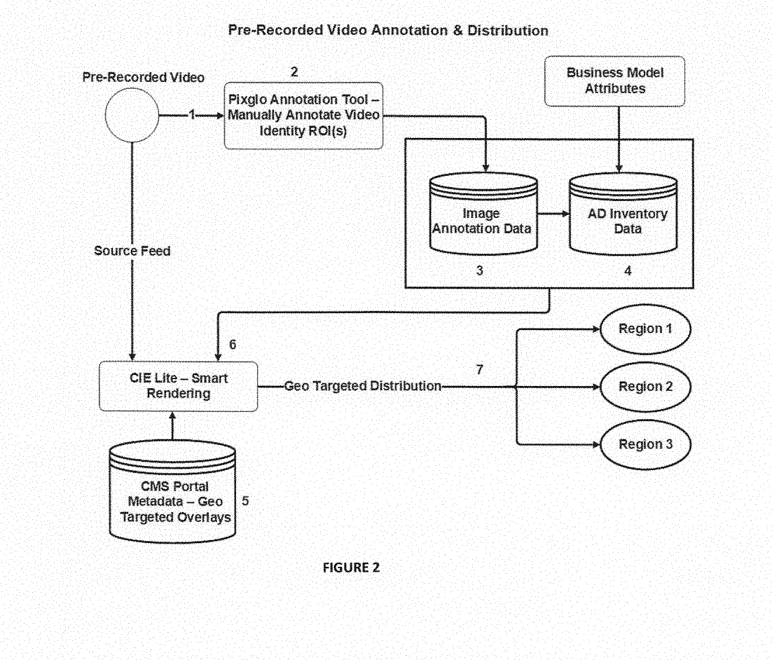

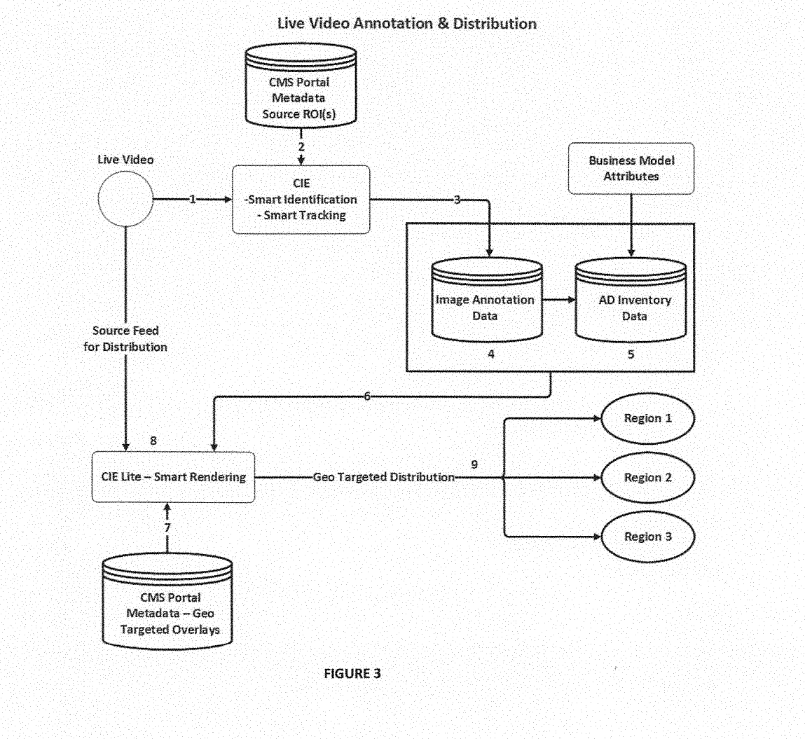

Referring to FIGS. 2 and 3, there is shown a method of ingestion of live and pre-recorded video, the annotation of Regions of interest (ROIs) within the frames, and the tracking and rendering of 2D & 3D objects.

As depicted in FIG. 2 and FIG. 3, the various components include:

A Video module configured to enable the ingestion of:

Pre-recorded videos (industry standard video formats) and the decomposition of these videos into frames that are then passed on to the annotation tool; and

Live videos passed to the Core Imaging Engine for tracking and rendering based on the information present in the CMS Portal.

A video annotation tool—configured to allow users to annotate video frames. Annotation of video frames refers to the following:

A graphical mechanism to identify the Regions-of-interest in a video where the 2D/3D objects need to be inserted during video distribution.

Identification of the meta-data about the ROI, including but not limited to the size, position in a video frame, shape, lighting, color and occlusion.

Image annotation data: annotated data stored in a way that the downstream Core Imaging Engine (CIE) can utilize the captured meta-data.

The annotated images are then made available for insertion of 2D and 3D objects during distribution.

The combination of the annotated Data & New 2D or 3D Image is used for the rendering by the CIE.

Region wise overlay information is stored in Cloud.

Core Imaging Engine is a series of AI/ML (machine learning) algorithms configured to utilize the date captured by the annotation tool as described, and the overlay 2D and 3D image data as described and insert the new 2D & 3D objects in the original video in place of the old image(s)/object(s) as annotated by the tool.

Video Module is configured to then distribute the new overlaid video to various geographies in real-time.

Though the disclosure has been described with respect to a specific preferred embodiment, many variations and modifications will become apparent to those skilled in the art upon reading the present application. The intention is therefore that the appended claims be interpreted as broadly as possible in view of the prior art to include all such variations and modifications.

1. A method of using annotated data to optimize tracking and rendering during video distribution.

2. A method of dynamically rendering annotated data, in real-time, onto a continuously deforming digital surface in live or pre-recorded video streams.
